(19) United States
(12) Patent Application Publication
(10) Pub. No.: US 2015/0331210 A1
(43) Pub. Date: Nov. 19, 2015

(54) OPTICAL FIBER CABLE ASSEMBLY WITH LOW RADIATED EMISSION COUPLING

(71) Applicant: Avago Technologies General IP (Singapore) Pte. Ltd., Singapore (SG)

(72) Inventor: Chi Keung Lee, Palo Alto, CA (US)

(73) Assignee: Avago Technologies General IP (Singapore) Pte. Ltd., Singapore (SG)

(21) Appl. No.: 14/143,195

(22) Filed: Dec. 30, 2013

(51) Int. Cl. G02B 6/42

(52) U.S. Cl. CPC G02B 6/4278; G02B 6/4212; G02B 6/4246; G02B 6/423; G02B 6/4277

(57) ABSTRACT

An AOC system includes an AOC optical module, a substantially cylindrical cable jacket, a bundle of optical fibers in the cable jacket, a metallic fiber holder, and a spring clip. A portion of the metallic fiber holder is seated within a recess in a metallic AOC module housing. The spring clip resiliently biases the portion of the metal fiber holder seated within the housing recess into contact with the metallic housing, promoting EMI shielding.

### BACKGROUND

In an optical communication system, an optical transmitter can convert electrical signals that are modulated with information into optical signals for transmission via an optical fiber. An opto-electronic light source, such as a laser, performs the electrical-to-optical signal conversion in an optical transmitter. An optical receiver can receive the optical signals via the optical fiber and recover the information by demodulating the optical signals. An opto-electronic light detector, such as a photodiode, performs the optical-to-electrical signal conversion in an optical receiver. In addition to light sources and light detectors, opto-electronic transmitters and receivers commonly include lenses, reflectors and other optical elements, mechanical structures for retaining such elements, and optical and electrical interconnections.

Optical transmitters and receivers can be modularized. That is, the above-referenced light sources, light detectors and optical elements can be included within a modular housing. Although various optical module formats are known, a common module format relates to the Small Form Factor Pluggable (SFP) family of module formats. The SFP family includes formats such as SFP+ and Quad SFP (QSFP). In an SFP module, the rearward end of the housing includes a receptacle into which the end of an optical fiber cable can be plugged. The plug that terminates the end of the optical fiber cable may be of the format known as LC, for example. The forward end of an SFP module includes an array of electrical contacts. The SFP module can be plugged into a cage, commonly referred to as an EMI (electromagnetic interference) cage, by inserting the forward end of the SFP module into one of a number of bays in the cage, until the electrical contacts make contact with mating contacts in the cage and a latch mechanism in the cage engages the SFP module. The SFP module includes a de-latch mechanism by which a user can disengage the SFP module from the cage. The de-latch mechanism commonly includes a pull-tab that a user can grasp to aid retracting the module from the cage.

An active optical cable (AOC) is, in effect, an optical fiber cable that is terminated at one or both ends with a modularized optical transceiver. In contrast with the above-described type of optical transceiver module, in an AOC the mechanical connection between the optical fiber cable and the transceiver module housing is not a plug-and-receptacle arrangement or otherwise operable by a user. Rather, in an AOC the connection between the optical fiber cable and the transceiver module housing is intended to remain mechanically and optically secure at essentially all times. The AOC transceiver module is configured to plug into an EMI cage or similar receptacle. The AOC transceiver module thus commonly includes a de-latch mechanism.

The connection between the optical fiber cable and AOC transceiver module can be a source of problems. One problem is that this connection commonly is not sufficiently mechanically strong to prevent the connection from being damaged if the optical fiber cable is inadvertently pulled or otherwise mishandled with sufficient force. Another problem is that this connection can serve as a source of radiated EMI that can impair the operation of nearby systems.

### SUMMARY

Embodiments of the present invention relate to an active optical cable (AOC) system. In exemplary embodiments, the AOC system includes an AOC optical module, a cable jacket having a substantially circular cross-sectional shape, a plurality of optical fibers extending through the cable jacket, a metallic fiber holder, and a spring clip. The AOC optical module has a metallic AOC transceiver module housing. The metallic fiber holder has a rearward end with a rearward fiber holder opening and a forward end with a substantially elongated rectangular forward fiber holder opening. A portion of the metallic fiber holder is seated within a recess in the metallic AOC transceiver module housing. The optical fibers form a parallel array as they extend through the forward fiber holder opening. The spring clip is mounted in the metallic AOC transceiver module housing and resiliently biases the portion of the metal fiber holder that is seated within the housing recess into contact with the metallic AOC transceiver module housing.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an AOC system, in accordance with an exemplary embodiment of the invention.

FIG. 2 is a perspective view of the fiber holder of an AOC transceiver module of the AOC system of FIG. 1.

FIG. 3 is a perspective view of a portion of a fiber cable assembly of an

AOC transceiver module of the AOC system of FIG. 1.

FIG. 4 is a similar to FIG. 3, showing the further inclusion of a crimp collar.

FIG. 5 is a perspective view of the complete fiber cable assembly of an AOC transceiver module of the AOC system of FIG. 1.

FIG. 6 is a top perspective view of the fiber cable assembly of FIG. 5 connected to an opto-electronic sub-assembly.

FIG. 7 is a bottom perspective view of the fiber cable assembly of FIG. 5 connected to an opto-electronic sub-assembly.

FIG. 8 is a schematic illustration of the optical paths in the opto-electronic sub-assembly of FIGS. 6-7.

FIG. 9 is a perspective view of the fiber cable assembly and opto-electronic sub-assembly of FIG. 7 mounted within the AOC transceiver module housing, with the transceiver module housing cover removed.

FIG. 10 is similar to FIG. 9, showing assembly of the AOC transceiver module housing cover to the remainder of the housing.

FIG. 11 is similar to FIG. 9, showing the fiber cable assembly and opto-electronic sub-assembly of FIG. 7 mounted within the AOC transceiver module housing from another perspective.

FIG. 12 is a sectional view taken along line 12-12 of FIG. 11.

FIG. 13 is an enlargement of a portion of FIG. 12.

FIG. 14 is a perspective view of the spring clip.

### DETAILED DESCRIPTION

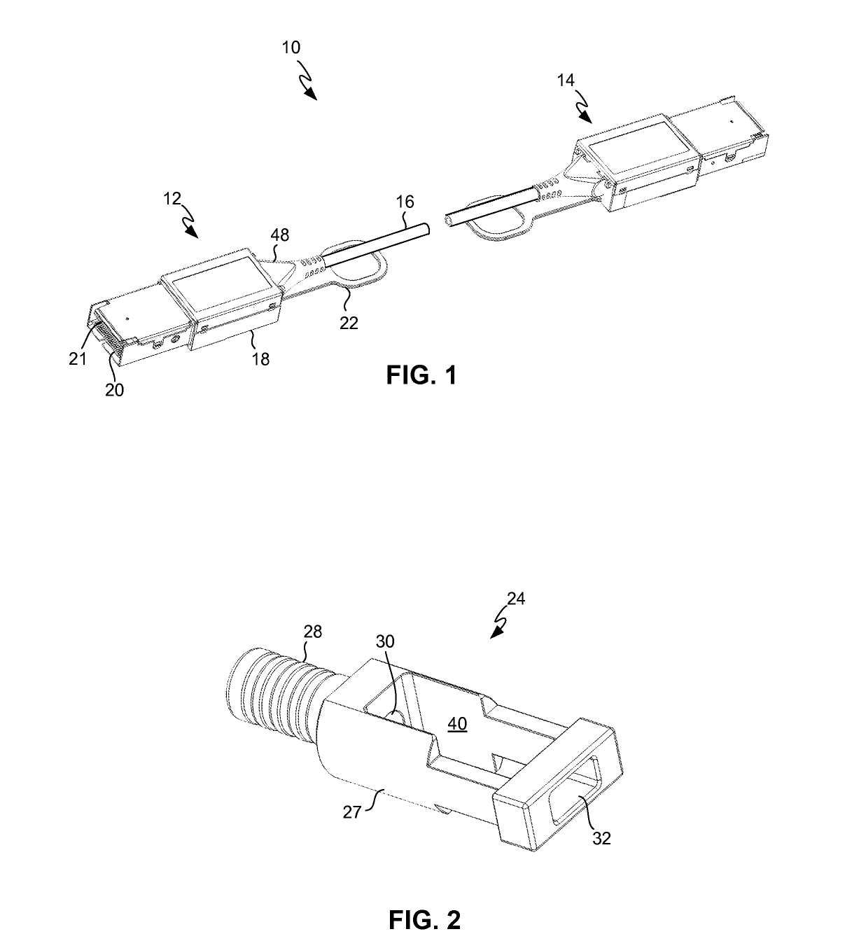

As illustrated in FIG. 1, in an illustrative or exemplary embodiment of the invention, an active optical cable (AOC) system 10 includes two AOC transceiver modules 12 and 14 that are connected together by a fiber optic cable 16. As AOC transceiver modules 12 and 14 are identical, for purposes of brevity only AOC transceiver module 12 is described in detail below.

As further illustrated in FIG. 1, AOC transceiver module 12 includes an AOC transceiver module sub-assembly 18. The forward end of AOC transceiver module sub-assembly 18 includes two arrays of electrical contacts 20 and 21. Although not shown for purposes of clarity, in preparation for operation, a user would plug the forward end of AOC transceiver module sub-assembly 18 into a transceiver bay of an EMI cage or similar system, such that the arrays of electrical contacts 20 and 21 make contact with mating contacts in the EMI cage. The AOC transceiver module 12 also includes a pull-tab de-latch mechanism 22, which is well known in the art and therefore not described in further detail herein. Also, for purposes of clarity, de-latch mechanism 22 is not shown in the remaining drawing figures.

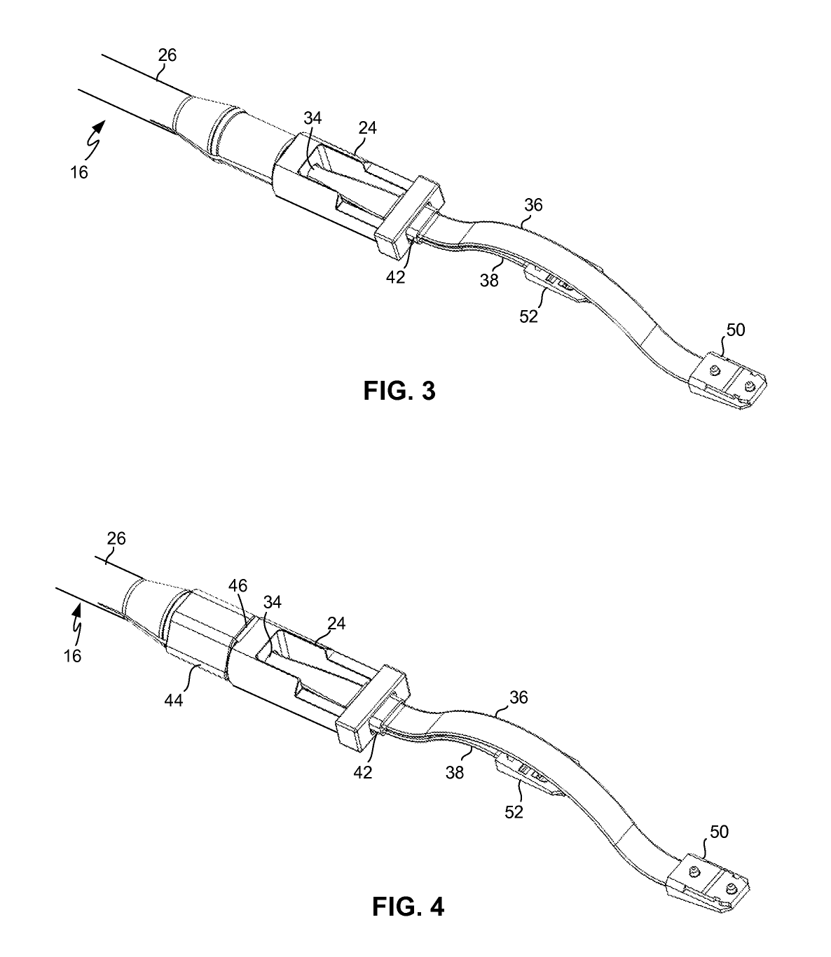

As illustrated in FIGS. 2-4, AOC transceiver module sub-assembly 18 includes a metallic fiber holder 24 and a substantially tubular (i.e., a circular cross-sectional shape) cable jacket 26 enclosing a plurality or bundle of optical fibers (not individually shown for purposes of clarity). Metallic fiber holder 24 can be made of, for example, metal injection molded stainless steel. That fiber holder 24 is made of metal is important because it contributes to shielding AOC transceiver module sub-assembly 18 against radiated EMI. With specific reference to FIG. 2, metallic fiber holder 24 includes a body portion 27 and a neck portion 28. Body portion 27 has a rearward end with a tubular rearward fiber holder opening 30 and a forward end with a substantially elongated rectangular forward fiber holder opening 32. Note in FIGS. 3-4 that the optical fibers together form a single substantially cylindrical array or bundle 34 where the fibers extend through the rearward fiber holder opening 30 (FIG. 2) and separate into two parallel fiber ribbon arrays 36 and 38, where the fibers extend through forward fiber holder opening 32 (FIG. 2). The separation or transition of the loose fibers between the bundle form and the parallel array form occurs within a cavity 40 (FIG. 2) between forward and rearward fiber holder openings 30 and 32. A ribbonization tool (not shown) can be used to ribbonize the loose fibers into fiber ribbon arrays 36 and 38.

As illustrated in FIGS. 3-4, within forward fiber holder opening 32 is an elastomeric fiber strain relief boot 42. Fiber strain relief boot 42 is retained snugly within forward fiber holder opening 32, i.e., it has an exterior shape conforming to the interior shape of forward fiber holder opening 32. Note that fiber ribbon arrays 36 and 38 are in a back-to-back orientation where they pass through forward fiber holder opening 32. Fiber ribbon arrays 36 and 38, in this back-to-back orientation, are retained snugly within two corresponding openings in fiber strain relief boot 42.

As illustrated in FIG. 3, an end of cable jacket 26 is split to aid fitting it over neck portion 28 (FIG. 2) of metallic fiber holder 24. Note in FIG. 2 that neck portion 28 has a corrugated exterior surface to aid securely receiving the end of cable jacket 26. As illustrated in FIG. 4, a crimp collar 44 secures the end of cable jacket 26 over neck portion 28. Crimp collar 44 is made of metal and tubular in shape before it is attached. The action of crimping crimp collar 44 over cable jacket 26 in the manner shown in FIG. 4 can cause crimp collar 44 to assume any suitable deformed shape, such as hexagonal, etc.

As illustrated in FIG. 4, after crimp collar 44 has been crimped over cable jacket 26, a metallic connection 46 comprising, for example, a fillet of electrically conductive (e.g., silver) epoxy or other suitable conductive material is applied between crimp collar 44 and the rearward end of metallic fiber holder 24. Metallic connection 46 ensures that crimp collar 44 is not electrically floating but rather at the same electrical potential (e.g., ground) as metallic fiber holder 24, thereby further promoting EMI shielding.

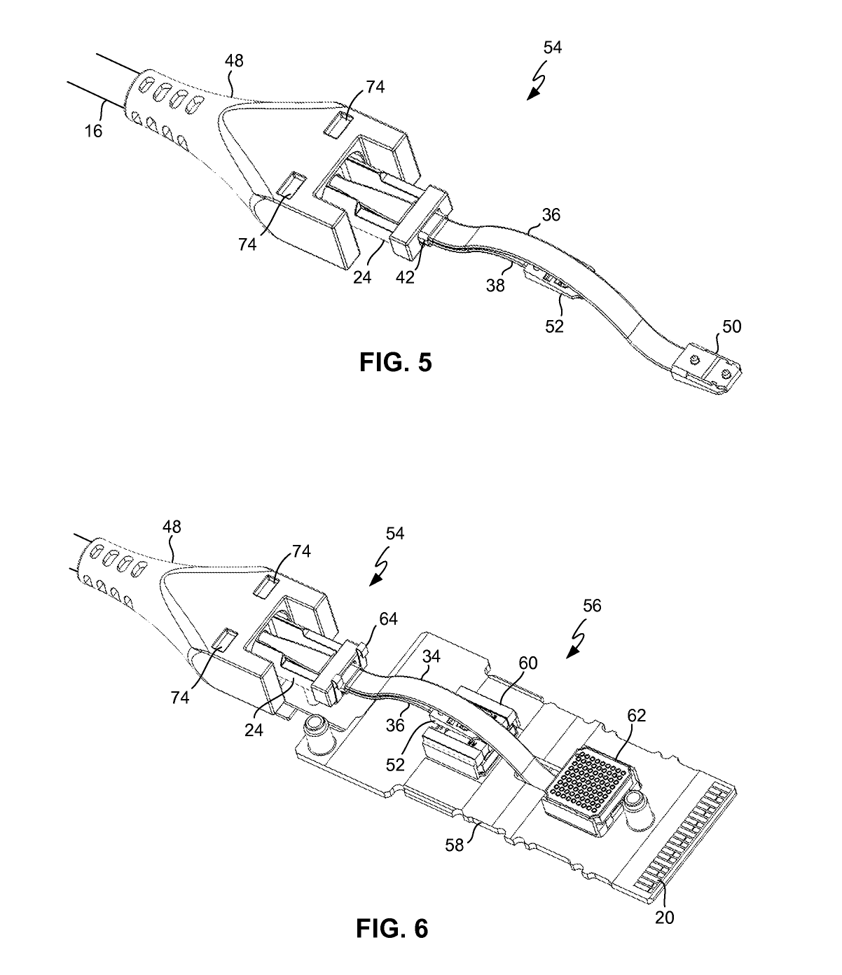

As illustrated in FIG. 5, AOC transceiver module 12 also includes a cable strain relief boot 48 made of an elastomeric material. Cable strain relief boot 48 surrounds a portion of cable jacket 26 and the rearward end of metallic fiber holder 24, including crimp collar 44. Note that the ends of fiber ribbon arrays 36 and 38 terminate within respective optics blocks 50 and 52, which are described below in further detail. With cable strain relief boot 48 included in this manner, the resulting fiber cable assembly 54 can be assembled to the remainder of AOC transceiver module sub-assembly 18.

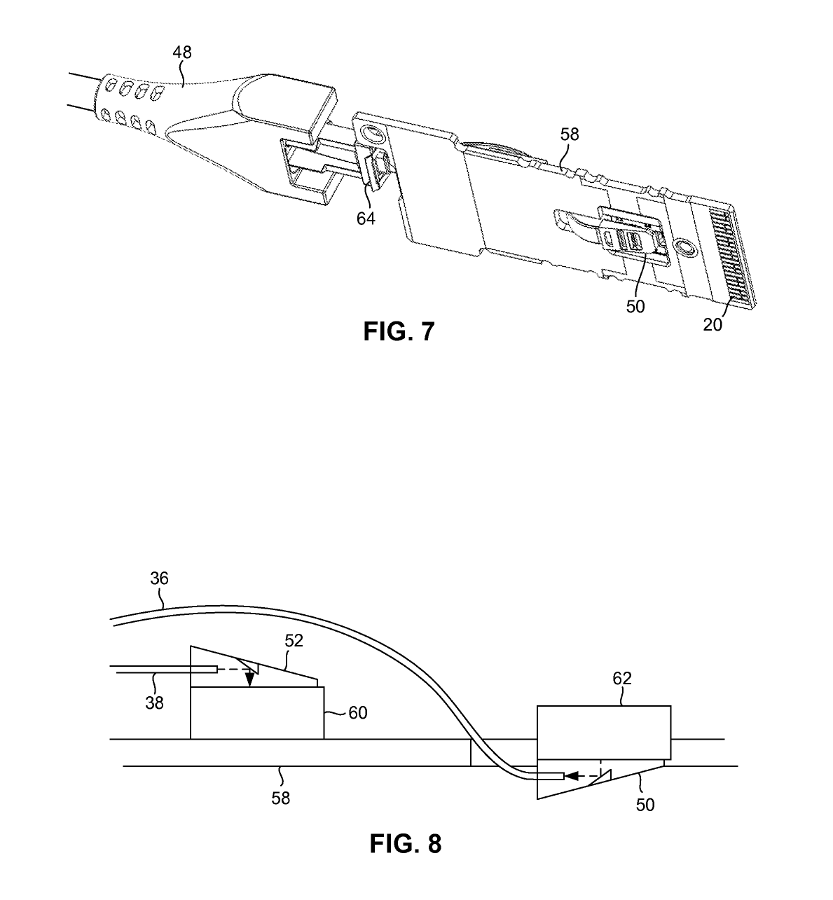

As illustrated in FIGS. 6-7, fiber cable assembly 54 is assembled to an opto-electronic sub-assembly 56, which includes a printed circuit board 58. Mounted on printed circuit board 58 are a receiver subsystem 60 and a transmitter subsystem 62. Receiver subsystem 60 includes another semiconductor device having an array of photodiodes. Transmitter subsystem 62 includes a semiconductor device having array of lasers, such as vertical cavity surface-emitting lasers (VCSELS). Other elements of receiver subsystem 60 and transmitter subsystem 62 are not shown for purposes of clarity, such as printed circuit boards, etc. Also shown in FIG. 6 is a spring clip 64, which is described in further detail below. Spring clip 64 is shown in FIG. 6 to emphasize its spatial relationship with metallic fiber holder 24, but spring clip 64 is not attached to fiber holder 24.

When fiber cable assembly 54 is assembled to opto-electronic sub-assembly 56, receiver subsystem 60 is optically aligned with optics block 52, and transmitter subsystem 62 is optically aligned with optics block 52, as diagrammatically illustrated in FIG. 8. In FIG. 8, the paths of optical signals that are emitted from the fiber end faces of fiber ribbon array 38 and are reflected by optics block 52 at a right angle onto receiver subsystem 60 are indicated in broken line. Similarly, the paths of optical signals that are emitted from transmitter subsystem 62 and reflected by optics block 50 at a right angle into the fiber end faces of fiber ribbon array 36 are indicated in broken line. (There is one such path for each optical fiber in fiber ribbon arrays 36 and 38.) Optics blocks 50 and 52 are well known in the art and therefore not described in further detail. Optics blocks 50 and 52 can be made of an optically transparent material, such as ULTEM® polyetherimide, available from SABIC Innovative Plastics of Saudi Arabia. As well understood by persons skilled in the art, the optical paths pass through this material and are reflected by features such as total internal reflection (TIR) surfaces formed in the material.

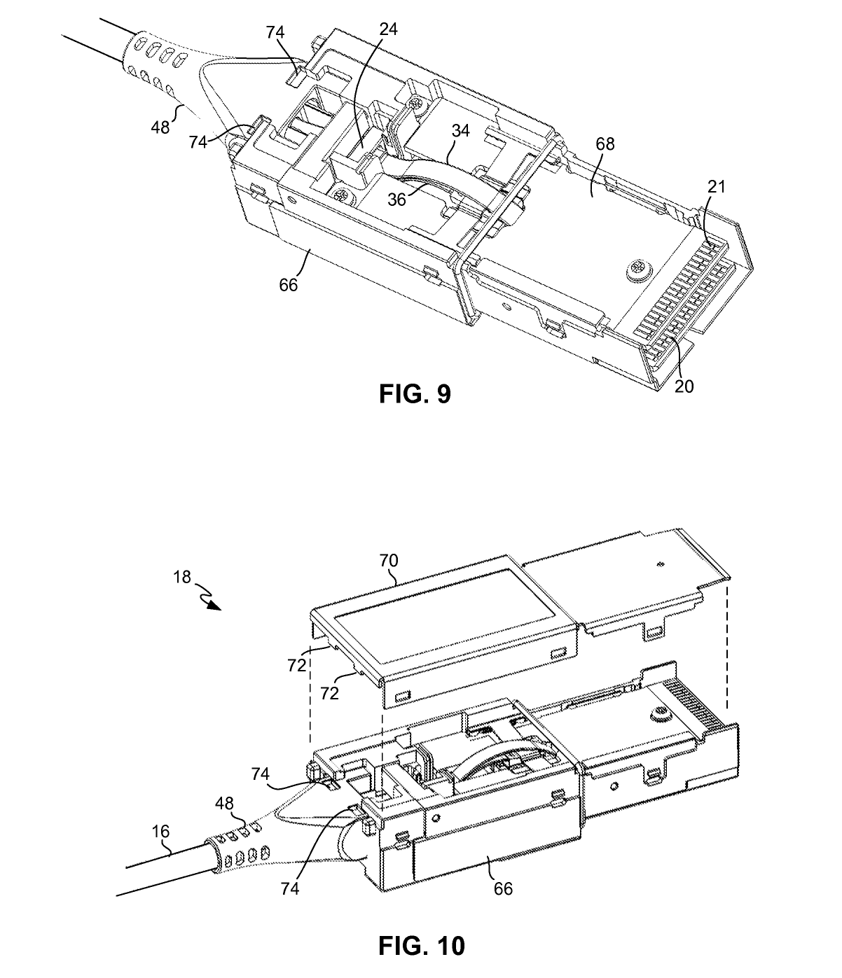

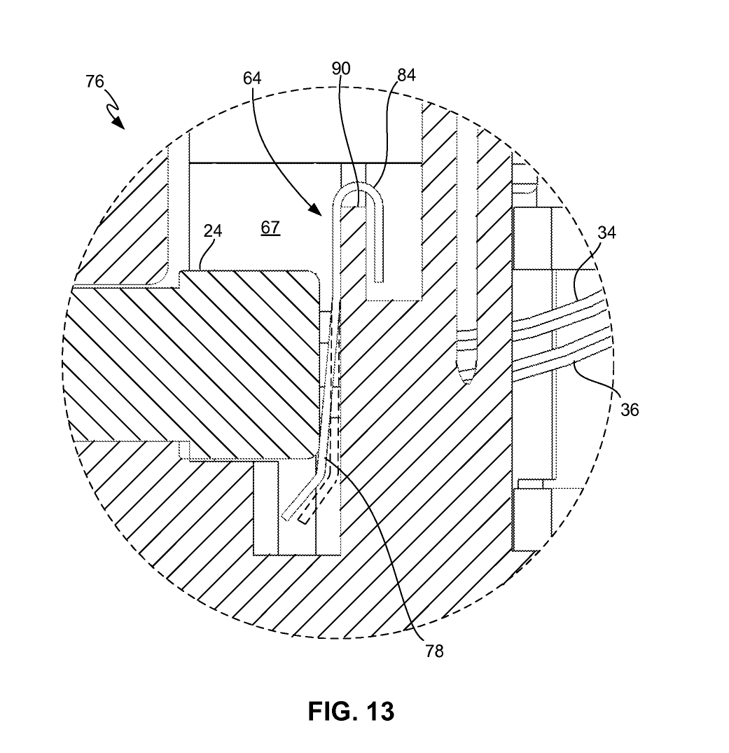

As illustrated in FIG. 9, above-described fiber cable assembly 54 and opto-electronic sub-assembly 56 are mounted within a metallic (e.g., die-cast) housing 66 of AOC transceiver module sub-assembly 18. The box-shaped forward end of metallic fiber holder 24 is securely seated within a correspondingly shaped recess 67 (FIG. 13) in metallic housing 66. Another printed circuit board 68, which includes the array of electrical transceiver modules 21, is mounted on opto-electronic sub-assembly 56. Although not shown for purposes of clarity, electrical contact is made between circuit paths in printed circuit board 68 and electrical contacts of receiver subsystem 62. Similarly, electrical contact is made between electrical contacts of transmitter subsystem 60 and circuit paths in printed circuit board 58, which includes the array of electrical transceiver modules 20.

As illustrated in FIG. 10, housing 66 includes a metallic cover 70. When cover 70 is attached to the remainder of housing 66 as shown in FIG. 10, two prongs 72 extending from cover 70 engage two correspondingly shaped recesses 74 in cable strain relief boot 48. This mechanical engagement makes cable strain relief boot 48 captive with respect to housing 66.

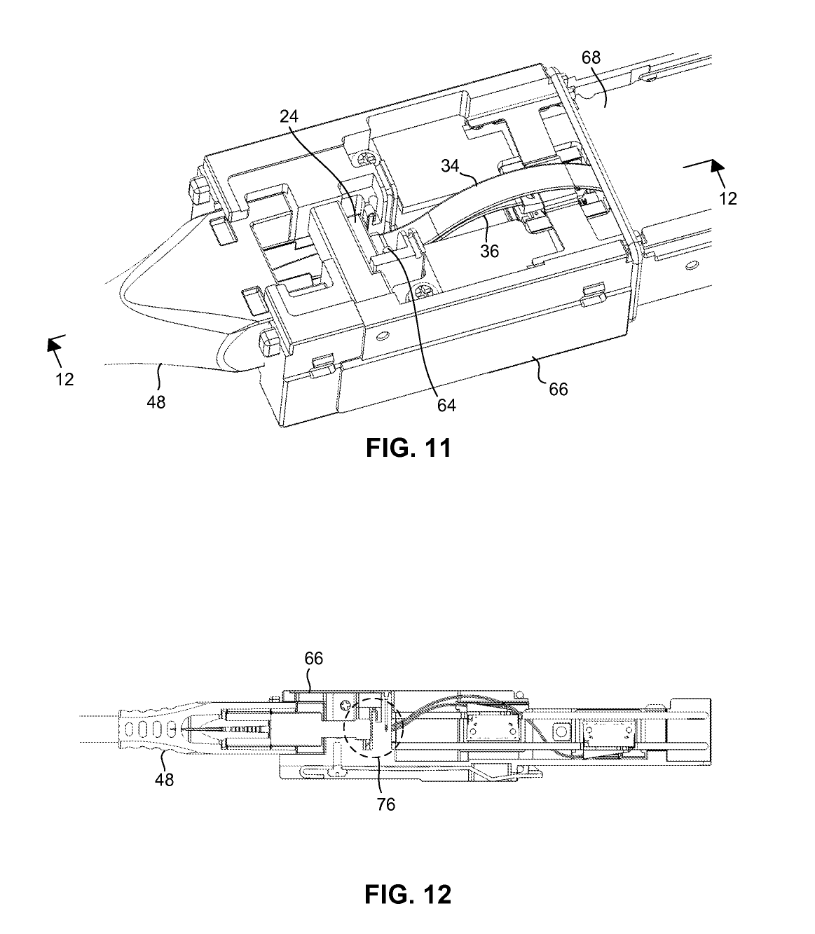

As illustrated in FIGS. 11-13, when AOC transceiver module 12 is fully assembled, portions of spring clip 64 contact and exert a resilient bias force against the forward end of fiber holder 24 with respect to housing 66. The bias force ensures good electrical contact between fiber holder 24 and housing 66. In addition, electrical contact between housing 66 and fiber holder 24 is made through spring clip 64 itself. The electrical grounding of crimp collar 44 and fiber holder 24 to housing 66 eliminates radiated noise signals and coupling from opto-electronic sub-assembly 56 to crimp collar 44 and fiber holder 24 due to antenna effects, thereby improving EMI shielding effectiveness in AOC transceiver module 12.

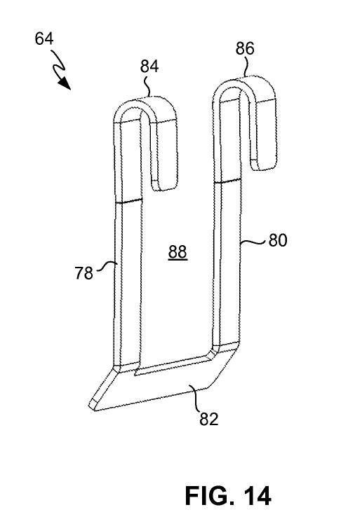

A portion 76 of FIG. 12 is shown enlarged in FIG. 13. Spring clip 64 is made of a resilient material such as sheet metal and thus can be flexed in a resilient manner between a flexed state (indicated in broken line in FIG. 13) and a relaxed state (indicated in solid line in FIG. 13). With further reference to FIG. 14, note that spring clip 64 is U-shaped, with two parallel arms 78 and 80 joined at their proximal ends by a cross member 82. The distal ends of arms 78 and 80 have hooks 84 and 86, respectively. Spring clip 64 has a central region 88 between arms 78 and 80. Hooks 84 and 86 engage a top wall 90 (FIG. 13) of recess 67 in which the forward end of fiber holder 24 is seated. Central region 88 is aligned with forward fiber holder opening 32. Thus, fiber ribbon arrays 36 and 38, which extend through forward fiber holder opening 32, also extend through central region 88, with arms 78 and 80 bearing against the forward end of fiber holder 24 on either side of forward fiber holder opening 32.

The above-described structure provides EMI shielding that inhibits radiation of signals generated by opto-electronic sub-assembly 56. The above-described structure also promotes secure mechanical connection between fiber cable assembly 54 and housing 66.

One or more illustrative embodiments of the invention have been described above. However, it is to be understood that the invention is defined by the appended claims and is not limited to the specific embodiments described.

What is claimed is:

1. An active optical cable (AOC) system, comprising:
an pluggable AOC optical module having a metallic AOC module housing and an electrical contact array;
a cable jacket having a substantially circular cross-sectional shape, the cable jacket coupled to a rearward end of the metallic AOC module housing;
a plurality of optical fibers extending through the cable jacket;
a metallic fiber holder having a rearward end with a rearward fiber holder opening and a forward end with a substantially elongated rectangular forward fiber holder opening, the metallic fiber holder having a portion seated within a housing recess in the metallic AOC module housing, the plurality of optical fibers forming a parallel array extending through the forward fiber holder opening; and
a spring clip mounted in the metallic AOC module housing, the spring clip resiliently biasing the portion of the metal fiber holder seated within the housing recess into contact with the metallic AOC module housing.

2. The AOC system of claim 1, wherein the spring clip is U-shaped, and the plurality of optical fibers forming a parallel array extend through a center region of the U-shaped spring clip.

3. The AOC system of claim 2, wherein the spring clip has two arms joined at a proximal end of each arm, and a distal end of each arm has a hook, the hook engaging a portion of the metallic AOC module housing, the arms resiliently biasing the portion of the metal fiber holder with respect to the metallic AOC module housing.

4. The AOC system of claim 3, wherein the portion of the metallic AOC module housing is a top of a wall of the housing recess.

5. The AOC system of claim 1, further comprising a metallic crimped collar compressing an end portion of the cable jacket onto a neck portion of the metallic fiber holder to retain the cable jacket and metallic fiber holder together.

6. The AOC system of claim 5, wherein the neck portion of the metallic fiber holder has a corrugated surface.

7. The AOC system of claim 5, wherein a metallic connection connects the metallic crimped collar is connected to the metallic fiber holder.

8. The AOC system of claim 7, wherein the metallic connection comprises electrically conductive epoxy.

9. The AOC system of claim 1, further comprising an elastomeric cable strain relief boot surrounding a portion of the cable jacket and a portion of the fiber holder, the cable strain relief boot having a forward end engaging a rearward end of the metallic AOC module housing.

10. The AOC system of claim 9, wherein:
the metallic AOC module housing has a prong; and
a forward end of the cable strain relief boot has a boot recess, the prong engaging the boot recess.

11. The AOC system of claim 1, further comprising an elastomeric fiber strain relief boot within the elongated rectangular opening of the metal fiber holder.

12. The AOC system of claim 11, wherein the plurality of optical fibers form a parallel array extending through a center region of the fiber strain relief boot.

13. The AOC system of claim 1, wherein:
the rearward fiber holder opening is tubular, and the plurality of optical fibers form a substantially cylindrical array extending through the rearward fiber holder opening; and
the metallic fiber holder has a cavity between the rearward fiber holder opening and the forward fiber holder opening, wherein the plurality of optical fibers transition between the substantially cylindrical array and the parallel array within the cavity.

14. An active optical cable (AOC) system, comprising:
a pluggable AOC optical module having a metallic AOC module housing;
a cable jacket having a substantially circular cross-sectional shape;
a plurality of optical fibers extending through the cable jacket;
a metallic fiber holder having a rearward end with a tubular rearward fiber holder opening, a forward end with a substantially elongated rectangular forward fiber holder opening, and a cavity between the rearward fiber holder opening and the forward fiber holder opening, the metallic fiber holder having a portion seated within a housing recess in the metallic AOC module housing, the plurality of optical fibers forming a substantially cylindrical array extending through the rearward fiber holder opening and a parallel array extending through the forward fiber holder opening and transitioning within the cavity between the substantially cylindrical array and the parallel array; and
a spring clip mounted in the metallic AOC module housing, the spring clip resiliently biasing the portion of the metal fiber holder seated within the housing recess into contact with the metallic AOC module housing.

15. The AOC system of claim 14, wherein the spring clip is U-shaped, and the plurality of optical fibers forming a parallel array extend through a center region of the U-shaped spring clip.

16. The AOC system of claim 15, wherein the spring clip has two arms joined at a proximal end of each arm, and a distal end of each arm has a hook, the hook engaging a portion of the metallic AOC module housing, the arms resiliently biasing the portion of the metal fiber holder with respect to the metallic AOC module housing.

17. The AOC system of claim 16, wherein the portion of the metallic AOC module housing is a top of a wall of the housing recess.

18. The AOC system of claim 14, further comprising a metallic crimped collar compressing an end portion of the cable jacket onto a neck portion of the metallic fiber holder to retain the cable jacket and metallic fiber holder together.

19. The AOC system of claim 18, wherein a metallic connection connects the metallic crimped collar is connected to the metallic fiber holder.

20. The AOC system of claim 19, wherein the metallic connection comprises electrically conductive epoxy.
